(19) United States
(12) Patent Application Publication
(10) Pub. No.: US 2026/0152282 A1
(43) Pub. Date: Jun. 4, 2026

(54) AIRCRAFT ACCESSORY MOUNT

(71) Applicant: PERFORM AIR INTERNATIONAL, INC., Gilbert, AZ (US)

(72) Inventor: RAYMOND C. BERG, Gilbert, AZ (US)

(21) Appl. No.: 19/118,923

(22) PCT Filed: Oct. 9, 2023
(86) PCT No.: PCT/US2023/034734

§ 371 Date: Apr. 7, 2025

Related U.S. Application Data
(60) Provisional application No. 63/414,258, filed on Oct. 7, 2022.

(51) Int. Cl. B64D 7/06

(52) U.S. Cl. CPC B64D 7/06

(57) ABSTRACT

Implementations described and claimed herein provide apparatus and methods for accessory attachment. One example apparatus includes an attachment device having a base plate, a support structure on the base plate, at least one pole, wherein the support structure is configured to support the at least one pole, a pintle configured to attach a weapon to the at least one pole, and one or more arms rotatably attached to the base plate, wherein each of the one or more arms includes an elongated opening configured to facilitate attachment of the base plate to an aircraft.

### CROSS-REFERENCE TO RELATED APPLICATIONS

This application claims the benefit of U.S. Provisional Patent Application Ser. No. 63/414,258, filed on Oct. 7, 2022 and entitled “AIRCRAFT ACCESSORY MOUNT,” which is hereby expressly incorporated by reference in its entirety herein.

### FIELD

Aspects of the present disclosure relate generally to a mount, such as a mount for an accessory to be mounted on an aircraft.

### BACKGROUND

Modern military aircrafts such as helicopters are equipped with various accessories, including weaponry. For example, a gun may need to be mounted on the aircraft with ease and in a manner that allows quick attachment and detachment of the gun. The gun may have to be mounted on the aircraft within a confined space and facilitate quick adjustment and movement of the gun from one aircraft to another. Moreover, the gun should be mounted on the aircraft in a manner that allows adjustments to the orientation of the gun during operation.

### SUMMARY

Some implementations of the present disclosure are directed to an accessory mount for an aircraft.

Some implementations provide an attachment device. The attachment device generally includes a base plate, a support structure on the base plate, at least one pole, wherein the support structure is configured to support the at least one pole, a pintle configured to attach a weapon to the at least one pole, and one or more arms rotatably attached to the base plate, wherein each of the one or more arms includes an elongated opening configured to facilitate attachment of the base plate to an aircraft.

Some implementations provide a method for accessory attachment. The method generally includes supporting, via a support structure on a base plate, at least one pole configured to attach an accessory for an aircraft to the base plate, and providing, via the base plate, pivot points for a first arm and a second arm rotatably attached to the base plate such that, in a collapsed position, a first side of the first arm is adjacent to a side of the base plate and a second opposite side of the first arm is adjacent to a side of the second arm.

Some implementations provide an attachment device. The attachment device generally includes a base plate, a support structure on the base plate, at least one pole configured to attach an accessory for an aircraft to the base plate, wherein the support structure is configured to support the at least one pole, first arm rotatably attached to a first corner portion of the base plate, and a second arm rotatably attached to a second corner portion of the base plate, wherein, in a collapsed position, a first side of the first arm is adjacent to a side of the base plate and a second opposite side of the first arm is adjacent to a side of the second arm.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1A illustrates an example attachment device for mounting an accessory onto an aircraft.

FIG. 1B illustrates an example base plate having ledges for coupling the base plate to base plate arms.

FIG. 2 illustrates example arms in extended positions.

FIGS. 3A and 3B illustrate isometric views of an example quick-mount device.

FIGS. 4A, 4B, and 4C illustrate isometric views of another example quick-mount device.

FIGS. 5A and 5B illustrate a side view and an isometric view of an example pintle and mount bushing.

FIG. 6 is a flow diagram illustrating example operations for accessory attachment.

### DETAILED DESCRIPTION

Aspects of the presently disclosed technology generally relate to systems and methods for attaching an accessory onto an aircraft (e.g., a helicopter). For example, an attachment device may allow fixed positioning of the accessory in at various locations and door positions (e.g., either a left door or a right door) of the aircraft.

The attachment device facilitates attachment of the accessory without modification to the airframe of the aircraft. In some examples, the accessory is a weapon. An existing aircraft structure may be used to provide a rigid mounting surface for the attachment device such that a solid firing position of the weapon is provided. The attachment device provides options for mounting the weapon in different positions on the aircraft, such as on a left side or a right side of the aircraft, as well as various means of attachments in such positions. The attachment device provided herein is collapsible to facilitate the transport of the attachment device (e.g., from one aircraft to another, or to storage), as described in more detail herein. Moreover, the attachment device may be disassembled for maintenance. For example, the attachment device is made of separate pieces that can be disassembled and can be manufactured individually in case of damage or replacement to any particular piece, reducing operating costs.

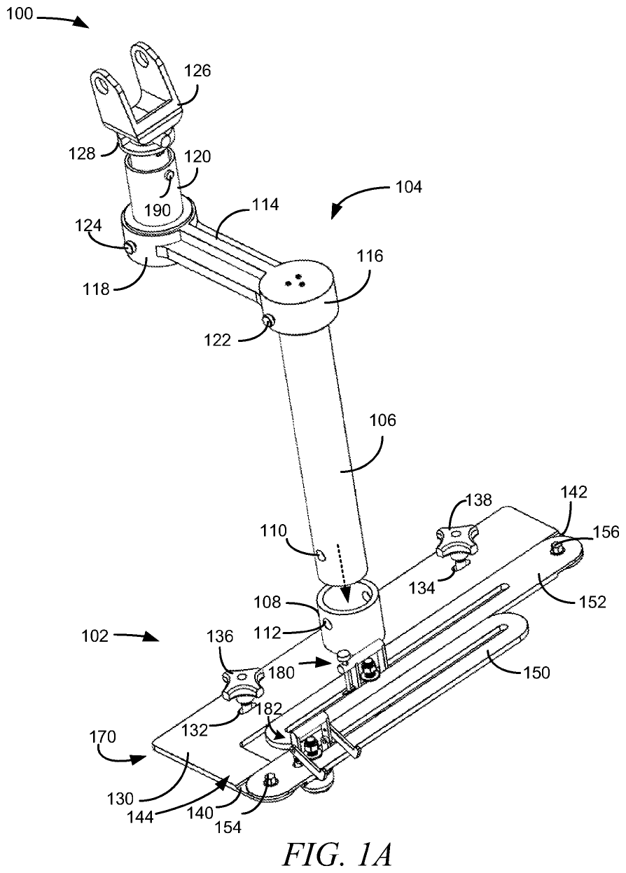

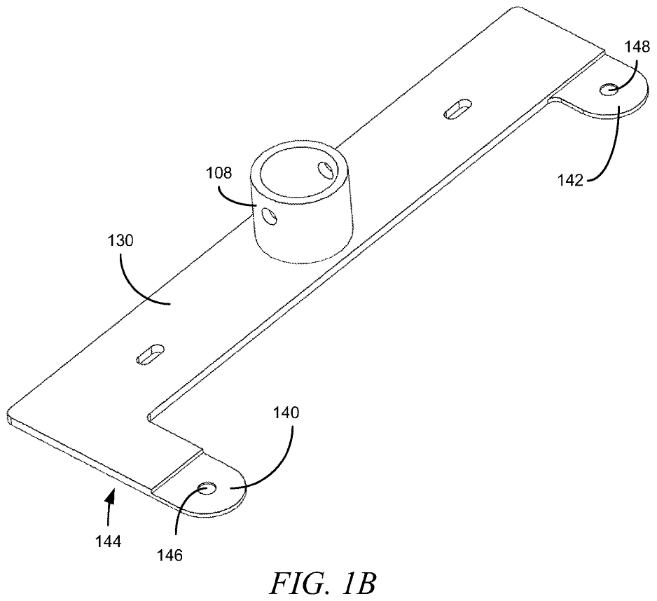

FIG. 1A illustrates an example attachment device 100 for mounting an accessory (e.g., a weapon) onto an aircraft, in accordance with certain aspects of the present disclosure. As shown, the attachment device 100 includes a base segment 102 that is detachably coupled to mount 104. Mount 104 can be configured to receive and removably secure the object to the base segment 102. The base segment 102 may include a base plate 130 having a receiver 108, which may be cylindrical. The mount 104 may include a pole 106 that may be coupled to the receiver 108 by aligning the pole 106 with the receiver 108. A pin can be placed through openings 110, 112 to secure the pole 106 within the receiver 108. The openings 110, 112, and the associated quick-release pin may be manufactured with a tolerance fit to prevent (or at least reduce) vibration or firing-related wear and tear.

In some implementations, a quick-release pin may be used for attaching pole 106 to the receiver 108. A quick-release pin allows rapid removal of the pole 106 (and a mounted object) during an emergency egress situation. For example, a user can use the quick-release pin to rapidly disconnect pole 106 from base plate 130 to take and store the object inside the aircraft.

As shown, an extension 114 (e.g., at a 90° angle) may be coupled to the pole 106. A distal end 116 of the extension 114 may be coupled to pole 106 at a 90° angle and secured via a pin 122. A distal end 118 of the extension 114 may be coupled to a pole 120 and secured via a pin 124. Any of the various pins described herein may be implemented as quick release pins to facilitate rapid detachment of any piece of the attachment device 100.

The pole 120 may be detachably coupled to a pintle 126 via a mount bushing 128 and secured via a pin 190. Although not shown, an object (e.g., a weapon) may be attached to the pintle 126. The extension 114 may be rotatable about an axis of the pole 106 and/or pole 120 (e.g., by removing pin 122 or pin 124). In other words, the position of the object that may be attached to the pintle 126 may be rotated around an axis along a length of pole 106 and/or pole 120. In some implementations, pin 122, pin 124, or both, may be replaced with a pull handle and a spring-loaded retention pin, allowing for the rotation of the pole 120 to a side position for revising a position of the object when not in use (e.g., so that the object can be stowed during transit flight and such that the object can be safely secured when not in use).

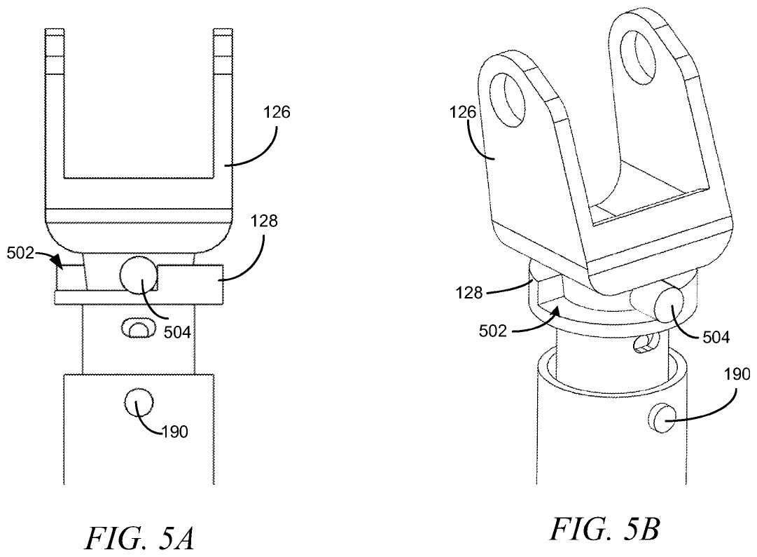

In some implementations, the length of the extension 114 may be set so that the object reaches past any barriers (e.g., a gate) that may be below the aircraft, allowing the object access below the aircraft. For example, a weapon may be attached to the mount with a length of the extension sufficient for the weapon to fire below the aircraft. As will be described in more detail herein with respect to FIGS. 5A and 5B, mount bushing 128 may be configured to limit an angle of rotation of pintle 126 and the weapon.

As shown, base plate 130 may include one or more openings for mounting base plate 130 to the aircraft. The openings may mirror a floor mounting structure of the aircraft. For example, base plate 130 may include opening 132 and opening 134, and mounts 136, 138 (e.g., thumbscrews) may be placed through openings 132, 134 to mount the base plate 130 to the aircraft. The thumbscrews facilitate rapid attachment of the base plate 130 to the aircraft and may be locked into place using locking hardware (e.g., fiber lock nuts, or castle nuts). While thumb screws are shown to facilitate understanding, any means for mounting base plate 130 to the aircraft may be used, such as using simple nuts and bolts.

FIG. 1B illustrates base plate 130 having ledges 140, 142 (also referred to herein as corner portions of the base plate 130) for coupling base plate arms to the base plate 130, in accordance with certain aspects of the present disclosure. In some aspects, each of the arms is an elongated shape composed of a rigid material. A thickness of the ledges 140, 142 of base plate 130 may be less than a thickness of a core portion 170 of the base plate 130, forming a shoulder that is operable to receive a respective end of a base plate arm. The thickness of the ledge 140 plus the thickness of an arm 150 attached to the ledge 140 may be equal to the thickness of the core portion 170 of the base plate such that, when attached, the top of the arm 150 is flush with the top of the base plate, as shown. Although shown as quadrilateral-shaped, the core portion 170 of the base plate 130 may be manufactured in different geometric shapes to adapt to different aircrafts.

Base plate 130 may include an extension portion 144 at one end. The extension portion may be a quadrilateral-shaped piece protruding from a corner of the core portion 170. The ledge 140 is directly adjacent to (e.g., protrudes from) the extension portion 144, as shown. The extension portion 144 facilitates collapsing of arms that may be coupled to ledges 140, 142 such that, when collapsed, arm 152 may be disposed between arm 150 and the core portion 170 of the base plate 130, as shown in FIG. 1A. The ledges 140, 142 also include respective openings 146, 148 through which mounts (e.g., screw) may be used to couple respective arms to ledges 140, 142.

Referring back to FIG. 1A, arms 150, 152 may be coupled to respective ledges 140, 142 via mounts 154, 156 (e.g., screws). The arms 150, 152 rotate about the pivot points at the mounts 154, 156. The arms 150, 152 are shown in a collapsed position in FIG. 1A. As described, extension portion 144 facilitates collapsing of the arms 150, 152. For example, when arms 150, 152 are in collapsed position, one side of arm 152 is directly disposed against (e.g., is adjacent to) the base plate 130 while arm 150 is directly disposed against (e.g., is adjacent to) another side (e.g., an opposite side) of arm 152, as shown.

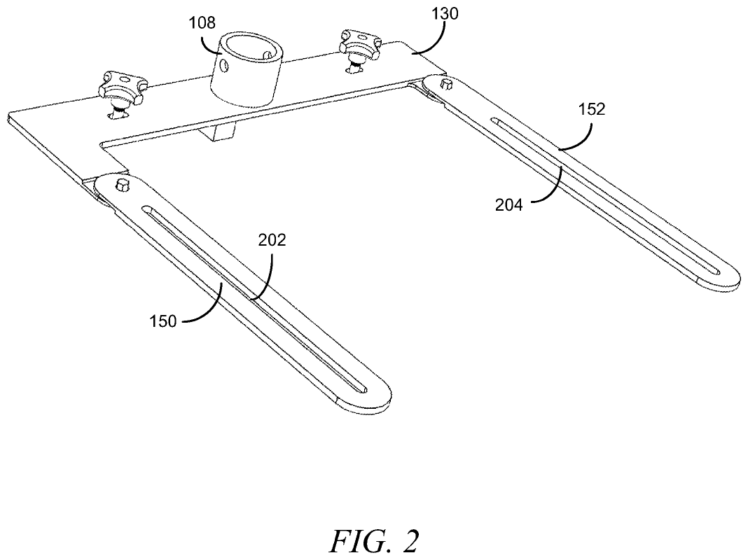

FIG. 2 illustrates arms 150, 152 in extended positions, in accordance with certain aspects of the present disclosure. As shown, each of the arms 150, 152 may be splayed out or rotated by 90° from the collapsed positions to the extended positions. In some implementations, the angle between each arm and the base plate may be 90° for crashworthiness and structural integrity under fire. In the extended positions, the arms 150 may extend further out from the base plate 130 than arm 150 (e.g., due to the extension portion 144 described with respect to FIG. 1A).

As shown, arms 150, 152 include elongated openings 202, 204, respectively, facilitating mounting of arms 150, 152 (and base plate 130) to the aircraft in various positions. For example, mounting holes may be at different positions in different aircrafts. Thus, the elongated openings 202, 204 allow mounting hardware to be used at different locations to mount base plate 130 to the aircraft. Any suitable type of mounting hardware may be used. Referring back to FIG. 1A, quick-mount devices 180, 182 may be used to attach respective arms 150, 152 to the aircraft.

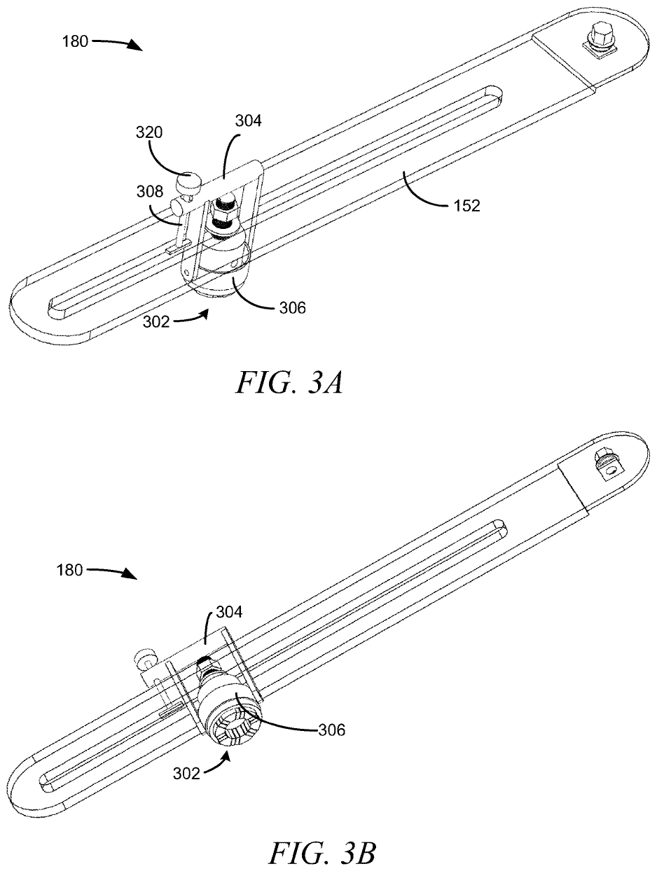

FIGS. 3A and 3B illustrate isometric views of the quick-mount device 180, in accordance with certain aspects of the present disclosure. As shown, arm 152 may be fastened to a quick-release attach 302 via screws and bolts. A handle 304 may be coupled to a sleeve 306 of the quick-release attach 302, allowing a user to pull the handle 304 to engage or release the arm 152 from the aircraft by pulling up the sleeve 306. The handle 304 allows engagement and release of arm 152 without having to manipulate quick-release attach 302 directly as the quick-release attach 302 may be difficult to reach. A pole 308 (e.g., also referred to as a “T-pole”) may be used to lock handle 304 in place. For example, pole 308 may be disposed through an opening in handle 304, as shown. The T-shaped end of pole 308 may be placed beneath arm 152 and a thumb screw 320 may be tightened to lock the handle in place.

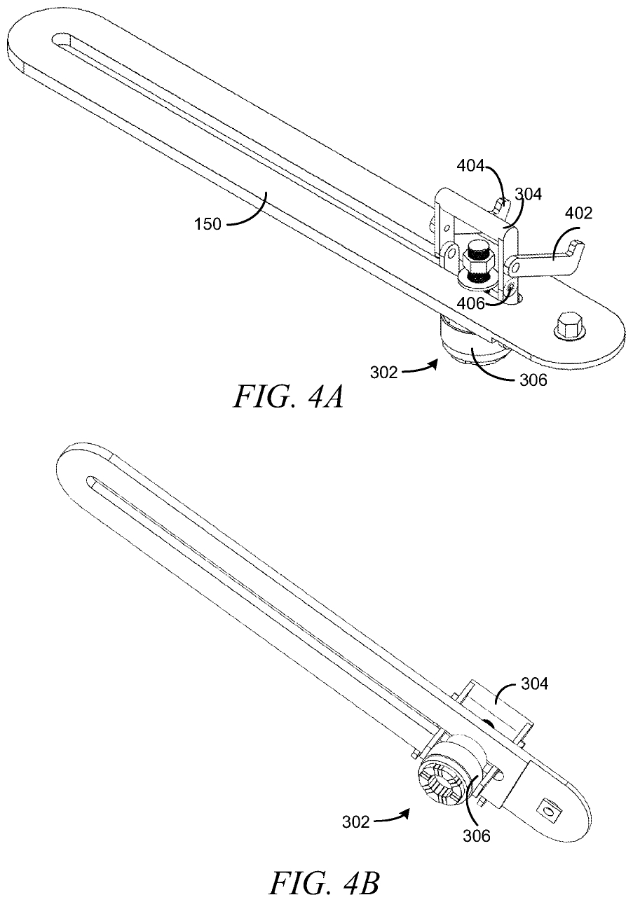

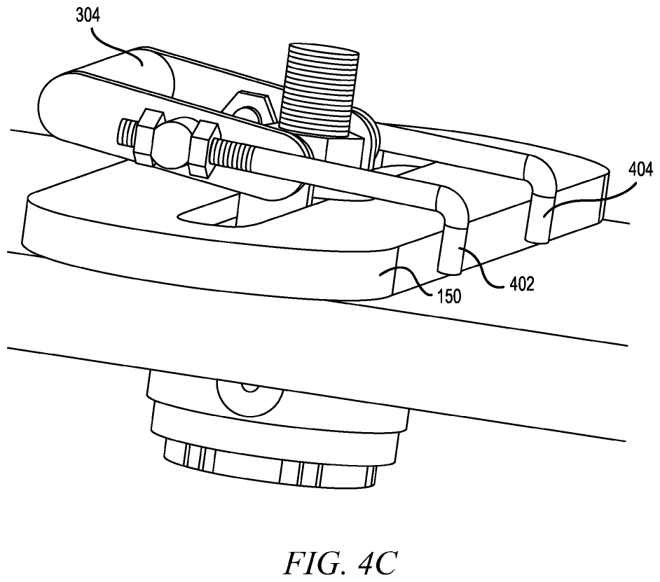

FIGS. 4A and 4B illustrate isometric views of the quick-mount device 182, in accordance with certain aspects of the present disclosure. Arm 150 may be fastened to a quick-release attach 302 via screws and bolts. The handle 304 may be coupled to sleeve 306 of quick-release attach 302, allowing an operator to pull the handle 304 to engage or release the arm 150 from the aircraft by pulling up the sleeve 306. Pressure lock levers 402, 404 allow the handle 304 to be locked into place. As shown, the handle may rotate at a pivot point 406, allowing the handle 304 to be folded by 90° in one direction, while the pressure lock levers 402, 404 fold by 90° in an opposite direction, making the handle flush, flat, and locked to the arm 150.

FIG. 4C illustrates quick-mount device 182 in a locked position, in accordance with certain aspects of the present disclosure. As shown, handle 304 is folded down in one direction and pressure lock levers 402, 404 are folded down in an opposite direction. Bends at ends of the levers 402, 404 grasp a side of arm 150, providing a pressure lock of the handle against the side of arm 150.

FIGS. 5A and 5B illustrate a side view and an isometric view of pintle 126 and mount bushing 128, in accordance with certain aspects of the present disclosure. In some implementations, the mount bushing 128 may be constructed to limit the rotational motion of the pintle (and consequently any object attached to pintle 126) within a specific angular range or angle (e.g., 90°). The mount bushing 128 may be a cylindrical support with a recess 502 in the cylindrical support. A pin 504 (e.g., also referred to as a field of fire pin) may be inserted into an opening of the pintle such that the pin 504 rests in the recess 502, as shown. The rotation of the pintle 126 may be limited due to contact of pin 504 with sides formed by the recess 502.

While the mount bushing 128 provides a limit of the rotation motion of the weapon, the poles 106, 120 provide a limit with respect to the vertical movement of the weapon. As a result, the mount bushing 128 and the poles 120, 106 prevent an operator (e.g., gunner) from damaging the aircraft when firing the weapon. In other words, the firing angle of the weapon is limited such that the weapon cannot point straight at any portion of the aircraft, thereby preventing user error that could result in aircraft damage or loss of life.

In some aspects, pin 190 may be implemented as a spring-loaded lock pin, which may be pulled to allow the pintle 126 to rotate past the otherwise limited rotational angle. While generally it is important to limit the field of fire to prevent damage to the aircraft, there are scenarios where an operator may want the weapon to rotate further, which may be performed by pulling pin 190 as described.

In some implementations, the height of poles 120, 106 may be selected to adapt the weapon mount to the overall height of the operator. For example, longer poles 120, 106 may be used to facilitate a weapon position for a user that may be taller.

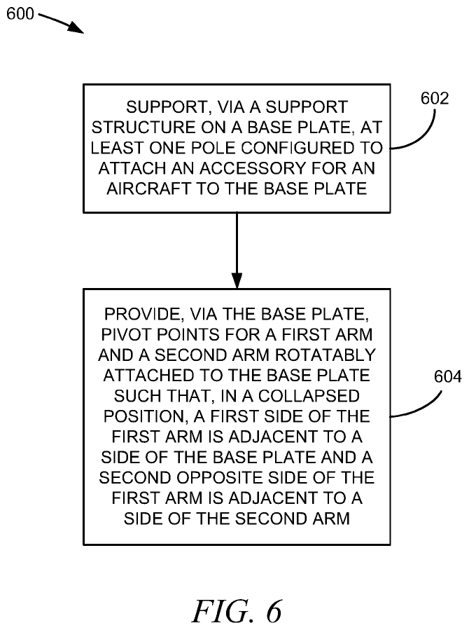

FIG. 6 is a flow diagram illustrating example operations 600 for an accessory attachment, in accordance with certain aspects of the present disclosure. The operations 600 may be performed, for example, with respect to a base segment such as the base segment 102.

The operations 600 begin, at block 602, with the base segment supporting, via a support structure (e.g., receiver 108) on a base plate (e.g., base plate 130), at least one pole (e.g., pole 106, pole 120, or both) configured to attach an accessory (e.g., a weapon) for an aircraft to the base plate.

At block 604, the base segment provides, via the base plate, pivot points (e.g., at mount 154 and mount 156) for a first arm (e.g., arm 152) and a second arm (e.g., arm 150) rotatably attached to the base plate such that, in a collapsed position, a first side of the first arm is adjacent to a side of the base plate and a second opposite side of the first arm is adjacent to a side of the second arm. In some aspects, in an extended position, the first arm is rotated at a corresponding one of the pivot points on a first corner portion (e.g., ledge 142) of the base plate and the second arm is rotated at another corresponding one of the pivot points on a second corner portion (e.g., ledge 140) of the base plate.

Certain aspects of the present disclosure are directed towards an attachment device, as described herein. The attachment device includes a base plate (e.g., base plate 130 of FIG. 1A), and a support structure (e.g., receiver 108) on the base plate, and at least one pole (e.g., pole 106 and pole 120. The support structure may be configured to support the at least one pole. In some aspects, the attachment device may include a pintle (e.g., pintle 126) configured to attach a weapon to the at least one pole and one or more arms rotatably attached to the base plate. Each of the one or more arms may include an elongated opening (e.g., opening 202 or opening 204) configured to facilitate attachment of the base plate to an aircraft.

In some aspects, the at least one pole comprises a first pole (e.g., pole 106) and a second pole (e.g., pole 120). The attachment device may also include an extension piece (e.g., extension 114) having a first end coupled to the first pole at a right angle and a second end coupled to the second pole at a right angle.

In some aspects, the base plate includes a core section (e.g., core portion 170) having a first thickness and a first arm attachment portion (e.g., ledge 142) having a second thickness. A first arm of the one or more arms may be attached to the first arm attachment portion. The second thickness of the first arm attachment portion may be less than the first thickness of the core section of the base plate. In some aspects, the first thickness of the core section is the same as the second thickness of the first arm attachment portion plus a thickness of the first arm. The first arm attachment portion may be at a corner portion of the base plate.

In some aspects, the one or more arms may include multiple arms. A second arm (e.g., arm 150) of the multiple arms is attached to a second arm attachment portion (e.g., ledge 140) of the base plate. The base plate may include an extension (e.g., extension portion 144) from the core section of the base plate. As shown in FIG. 1A, the extension may be between the second arm attachment portion and the core section. In some aspects, a length of the extension from the core section of the base plate to the second arm attachment portion is the same as a length of the first arm attachment portion to which the first arm is attached.

In some aspects, the base plate has one or more openings (e.g., openings 132, 134) configured to facilitate attachment of the base plate to the aircraft. In some aspects, the attachment device also includes a quick-release attachment (e.g., quick-release attach 302) disposed below an arm of the one or more arms and attached to the arm via the elongated opening. A handle (e.g., handle 304) may be disposed above the arm and attached to a sleeve (e.g., sleeve 306) of the quick-release attachment. The handle may be configured to rotate towards a first side of the arm (e.g., as shown in FIG. 4C). The attachment device may also include one or more pressure lock levers (e.g., levers 402, 404). A bend at an end of each of the one or more pressure lock levers may grasp a second opposite side of the arm when the handle is rotated towards the first side.

In some aspects, the attachment device also includes a cylindrical support (e.g., mount bushing 128) disposed between the at least one pole and the pintle, the cylindrical support having a recess (e.g., recess 502) and a pin (e.g., pin 504) attached to the pintle and resting in the recess. The recess may be configured to limit a rotation of the pintle due to contact of the pin to sides formed by the recess.

Based upon design preferences, it is understood that the specific order or hierarchy of steps in the methods described herein can be rearranged while remaining within the disclosed subject matter. Any accompanying method claims present elements of the various steps in a sample order and are not necessarily meant to be limited to the specific order or hierarchy presented. Similarly, the illustrations and examples provided herein are for explanatory purposes and are not intended to limit the scope of the appended claims. It will be recognized that those skilled in the art that changes and/or modifications may be made to the above described embodiment without departing from the concepts of the disclosure. It is therefore understood that the disclosure is not limited to the particular embodiments described but is intended to cover all modifications and changes within the scope and spirit of the disclosure.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

The above specification, examples, and data provide a complete description of the structure and use of example implementations of the present disclosure. Various modifications and additions can be made to the exemplary implementations discussed without departing from the spirit and scope of the presently disclosed technology. For example, while the implementations described above refer to particular features, the scope of this disclosure also includes implementations having different combinations of features and implementations that do not include all of the described features. Accordingly, the scope of the presently disclosed technology is intended to embrace all such alternatives, modifications, and variations together with all equivalents thereof.

What is claimed is:

1. An attachment device, comprising:
a base plate;
a support structure on the base plate;
at least one pole, wherein the support structure is configured to support the at least one pole;
a pintle configured to attach a weapon to the at least one pole; and
one or more arms rotatably attached to the base plate, wherein each of the one or more arms includes an elongated opening configured to facilitate attachment of the base plate to an aircraft.

2. The attachment device of claim 1, wherein the at least one pole comprises a first pole and a second pole, the attachment device further comprising an extension piece having a first end coupled to the first pole and a second end coupled to the second pole.

3. The attachment device of claim 1, wherein:
the base plate includes a core section having a first thickness and a first arm attachment portion having a second thickness;
a first arm of the one or more arms is attached to the first arm attachment portion; and
the second thickness of the first arm attachment portion is less than the first thickness of the core section of the base plate.

4. The attachment device of claim 3, wherein the first thickness of the core section is the same as the second thickness of the first arm attachment portion plus a thickness of the first arm.

5. The attachment device of claim 3, wherein the first arm attachment portion is at a corner portion of the base plate.

6. The attachment device of claim 3, wherein the one or more arms comprise multiple arms, and wherein a second arm of the multiple arms is attached to a second arm attachment portion of the base plate.

7. The attachment device of claim 6, wherein the base plate comprises an extension from the core section of the base plate, wherein the extension is between the second arm attachment portion and the core section.

8. The attachment device of claim 7, wherein a length of the extension from the core section of the base plate to the second arm attachment portion is the same as a length of the first arm attachment portion to which the first arm is attached.

9. The attachment device of claim 1, wherein the base plate has one or more openings configured to facilitate attachment of the base plate to the aircraft.

10. The attachment device of claim 1, further comprising:
a quick-release attachment disposed below an arm of the one or more arms and attached to the arm via the elongated opening; and
a handle disposed above the arm and attached to a sleeve of the quick-release attachment.

11. The attachment device of claim 10, wherein:
the handle is configured to rotate towards a first side of the arm;
the attachment device further comprises one or more pressure lock levers; and
a bend at an end of each of the one or more pressure lock levers grasps a second opposite side of the arm when the handle is rotated towards the first side.

12. The attachment device of claim 1, further comprising:
a cylindrical support disposed between the at least one pole and the pintle, the cylindrical support having a recess; and
a pin attached to the pintle and resting in the recess.

13. The attachment device of claim 12, wherein the recess is configured to limit a rotation of the pintle due to contact of the pin to sides formed by the recess.

14. The attachment device of claim 1, wherein the aircraft comprises a helicopter.

15. An attachment device, comprising:
a base plate;
a support structure on the base plate;
at least one pole configured to attach an accessory for an aircraft to the base plate, wherein the support structure is configured to support the at least one pole;
a first arm rotatably attached to a first corner portion of the base plate; and
a second arm rotatably attached to a second corner portion of the base plate, wherein, in a collapsed position, a first side of the first arm is adjacent to a side of the base plate and a second opposite side of the first arm is adjacent to a side of the second arm.

16. The attachment device of claim 15, wherein in an extended position, the first arm is rotated at a pivot point on the first corner portion and the second arm is rotated at a pivot point on the second corner portion.

17. The attachment device of claim 15, wherein the first corner portion of the base plate has a first thickness and a core portion of the base plate has a second thickness, wherein the first thickness of the first corner portion is less than the second thickness of the core portion of the base plate.

18. The attachment device of claim 17, wherein the base plate comprises an extension from a core section of the base plate, wherein the extension is between the second corner portion and the core portion of the base plate.

19. The attachment device of claim 15, further comprising:
a quick-release attachment disposed below the first arm and attached to the first arm via an elongated opening in the first arm; and
a handle disposed above the first arm and attached to a sleeve of the quick-release attachment.

20. A method for accessory attachment, comprising:
supporting, via a support structure on a base plate, at least one pole configured to attach an accessory for an aircraft to the base plate; and
providing, via the base plate, pivot points for a first arm and a second arm rotatably attached to the base plate such that, in a collapsed position, a first side of the first arm is adjacent to a side of the base plate and a second opposite side of the first arm is adjacent to a side of the second arm.
